(19) United States
(12) Patent Application Publication
(10) Pub. No.: US 2015/0094872 A1
(43) Pub. Date: Apr. 2, 2015

(54) WIRELESS SWITCH FOR USE IN INTERNET OF THINGS

(71) Applicant: Ijoy Obtain International Corp., Ltd., Taoyuan City (TW)

(72) Inventor: Tsai-Wan HUANG, Taoyuan City (TW)

(21) Appl. No.: 14/466,964

(22) Filed: Aug. 23, 2014

(30) Foreign Application Priority Data
Sep. 30, 2013 (TW) 102218234

(51) Int. Cl. G06F 1/32; G05F 1/66

(52) U.S. Cl. CPC G06F 1/3287; G05F 1/66
USPC 700/297

(57) ABSTRACT

A wireless switch for use in internet of things comprises: a control unit, provided with a display installed with an application program; a switch unit, one end thereof is coupled to the control unit through a wired network or a wireless network, and the other end thereof is provided with a first wireless module; and a termination unit, disposed in a patch board and coupled to a switch or a socket, the switch or the socket is coupled to a computer or a household appliance, and the termination unit is provided with a second wireless module for being communicated with the first wireless module; through the application program of the control unit, the switch unit and the termination unit are enabled to control the computer or the household appliance to be turned on or turned off.

### BACKGROUND OF THE INVENTION

1. Field of the Invention The present invention relates to a wireless switch, especially to a wireless switch for use in internet of things.

2. Description of Related Art

An internet of things is a network frame used for gathering the information of good shipping and positioning through a wireless sensing technology and utilizing the internet for management and control. The raw model is mentioned in the book “The road ahead” written by Bill Gates 15 years ago; however, the network infrastructure at the time was not as well developed as today, so the model was not popular at that time period.

In 2005, the international telecommunication unit (ITU) published a report for the internet of things and the substantial concept of internet of things was provided, and in 2008, IBM proposed a concept of intelligent globe, and the U.S. also raises the internet of things to a national and development strategy level, and the sensing technology and intelligent infrastructure are emphasized.

From 2009, regions or countries such as the European Union, Japan, China and South Korea also raised the internet of things to the national development level. And in 2014, the global users for wireless broadband network (not including conventional dialing) is estimated to reach 400 million; with the global machine to machine (M2M) market scale reaching 15 billion USD, the gross product of internet of things at 2020 is estimated to be 30 times more than the current internet.

The internet/cloud computing is to send a request from a user end to a cloud, and the cloud provides a real-time response service for forming an application delivery. However, this type of service is not suitable to be applied in an operating status in which tremendous amounts of objects requiring the sensing network and the internet of things for sending massive data to the cloud.

Moreover, due to the global warming and the climate changing, severe disasters have happened in various places, the natural disasters (drought and flood) which may happen once in several decades or centuries now happen in several years, thereby causing tremendous lost in properties and lives.

Saving power and reducing carbon consumption is the only way to slow down the global warming As such, every country has been advocating the concept of saving power and reducing carbon consumption, for example: taking public transportation system instead of driving vehicles, using intelligent electric meter and saving domestic power can be beneficial to the purpose of saving power and reducing carbon consumption.

Wherein, a house energy management system (HEMS) is to centrally manage each energy-consuming equipment such as a lamp or electric-driven vehicle or electric equipment, so a user can turn on or turn off the lamp or the electric equipment with a remote control means, meanwhile each parameter of the electric power system is able to be uploaded to the terminal equipment of the user thereby providing reference to the user and achieving an objective of lowering the electric power consumption.

The above-mentioned house energy management system can be applied in the internet of things, and a wireless switch can be adopted for achieving the objective of remotely turning on or turning off the lamp or the electric equipment.

Referring to FIG. 1, which is a schematic view illustrating the operating status of a conventional wireless switch. As shown in FIG. 1, in the conventional wireless switch, a switch and a control unit (not shown in FIG. 1) are disposed in a case 100, then the case 100 is inserted in a socket (not shown in FIG. 1) mounted on a wall. The case 100 is provided with at least a socket 110, and the socket 110 allows an electric equipment, e.g. but not limited to an air conditioner or a television, to be inserted.

However, the above-mentioned wireless switch is protruded out from the wall, so disadvantages of accidentally collision and affecting the interior appearance are caused.

### SUMMARY OF THE INVENTION

One primary objective of the present invention is to provide a wireless switch for use in internet of things, in which at least a termination unit is provided and disposed in a patch board of a power source, so no protrusion is formed on a wall thereby providing a better appearance.

Another objective of the present invention is to provide a wireless switch for use in internet of things, in which an application program is installed in a control unit, so a user is allowed to control the wireless switch to be opened or closed through the application program.

One another objective of the present invention is to provide a wireless switch for use in internet of things, in which an application program is installed in a control unit, and the application program is able to display the power consumption status of an electric equipment thereby being provided with an advantage of recoding and managing the power consumption of the relevant product so as to save power.

For achieving aforesaid objectives, the present invention provides a wireless switch for use in internet of things, which comprises: a control unit, provided with a display installed with an application program; a switch unit, one end thereof is coupled to the control unit through a wired network or a wireless network, and the other end thereof is provided with a first wireless module; and a termination unit, disposed in a patch board and coupled to a switch or a socket, the switch or the socket is coupled to a computer or a household appliance, and the termination unit is provided with a second wireless module for being communicated with the first wireless module; through the application program of the control unit, the switch unit and the termination unit are enabled to control the computer or the household appliance to be turned on or turned off.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view illustrating the operating status of a conventional wireless switch;

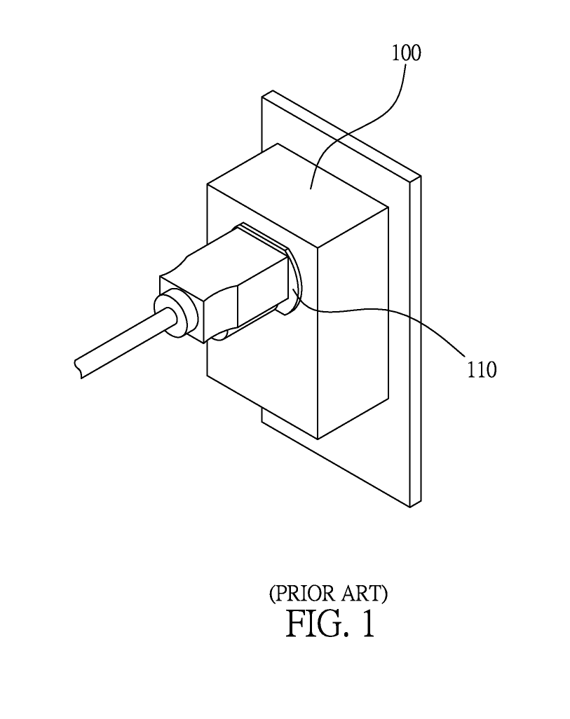

FIG. 2 is a schematic view illustrating the operating status of the wireless switch for use in internet of things according to one preferred embodiment of the present invention;

FIG. 3 is a block diagram illustrating the switch unit according to one preferred embodiment of the present invention;

FIG. 4 is a block diagram illustrating the termination unit according to one preferred embodiment of the present invention;

FIG. 5 is a block diagram illustrating the switch unit according to another preferred embodiment of the present invention;

FIG. 6 is a block diagram illustrating the switch unit according to one another preferred embodiment of the present invention;

FIG. 7 is a schematic view illustrating the connection between the termination unit and a socket according to one another preferred embodiment of the present invention; and

FIG. 8 is a schematic view illustrating the connection between the termination unit and a switch according to one another preferred embodiment of the present invention.

### DETAILED DESCRIPTION OF THE PREFERRED EMBODIMENT

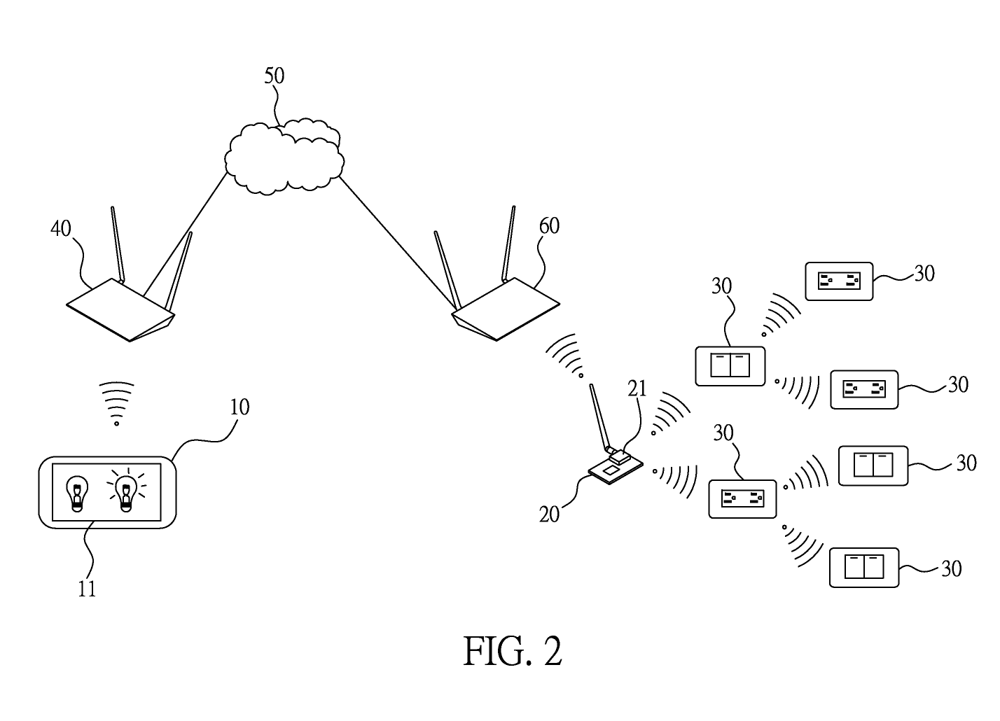

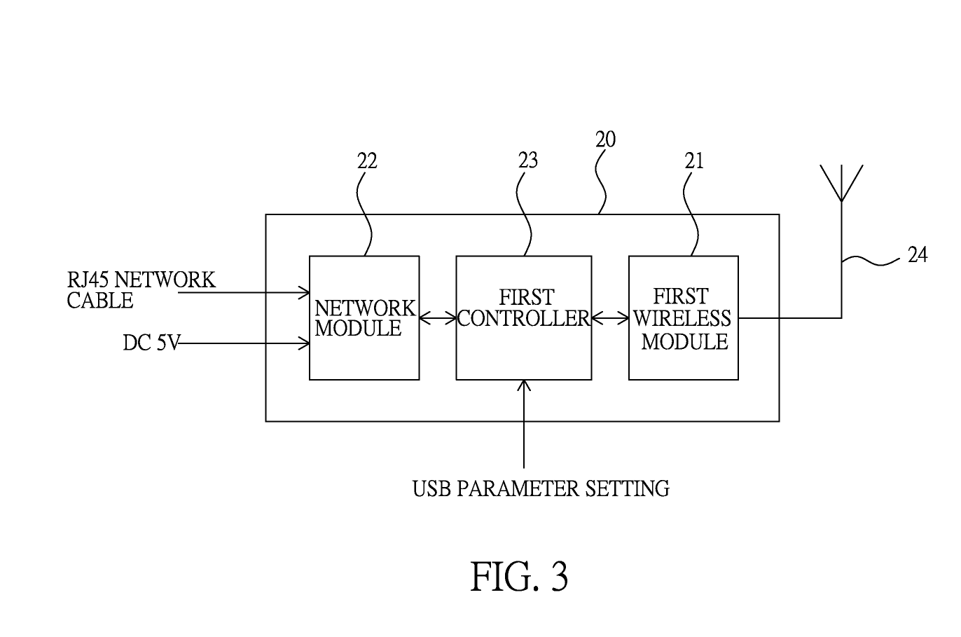

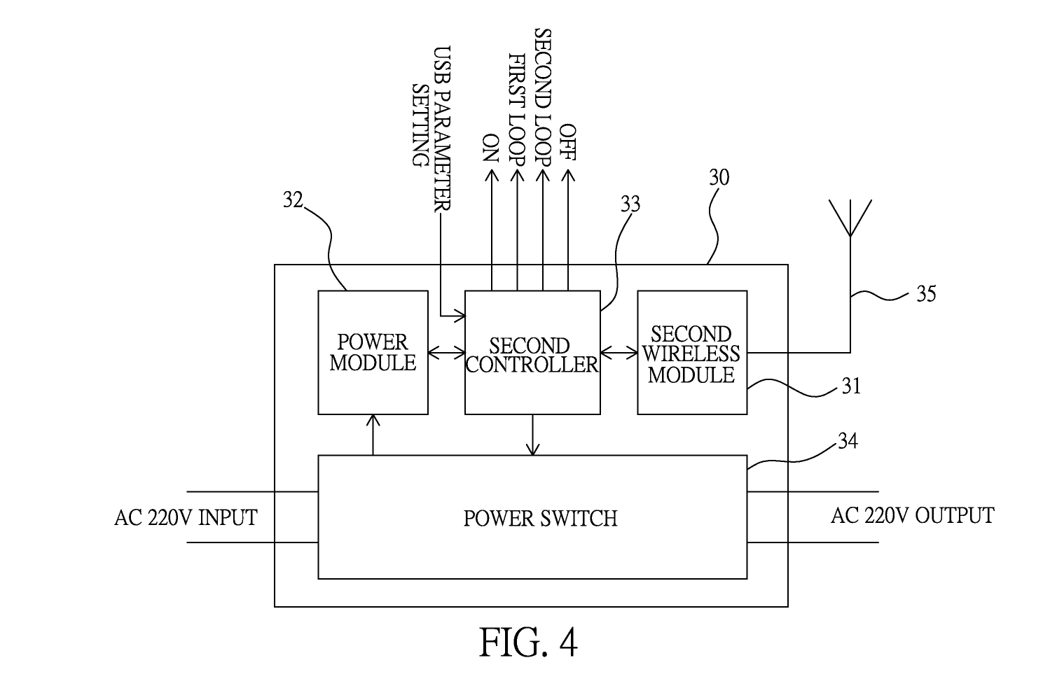

Referring from FIG. 2 to FIG. 4, wherein FIG. 2 is a schematic view illustrating the operating status of the wireless switch for use in internet of things according to one preferred embodiment of the present invention; FIG. 3 is a block diagram illustrating the switch unit according to one preferred embodiment of the present invention; and FIG. 4 is a block diagram illustrating the termination unit according to one preferred embodiment of the present invention.

As shown in figures, the present invention provides a wireless switch for use in internet of things, which includes a control unit 10, a switch unit 20, and at least a termination unit 30.

The control unit 10 is e.g. but not limited to a hand-held device, e.g. but not limited to a smart phone or a tablet computer; and the control unit 10 is provided with a display 11 installed with an application program (APP, not shown in figures). Wherein, the display 11 is e.g. but not limited to a liquid crystal display (LCD), and the display 11 is able to show the power consumption information of a computer or a household appliance (not shown in figures), e.g. but not limited to the current or power consumption.

One end of the switch unit 20 is coupled to the control unit 10 through a wired network or a wireless network, and the other end thereof is provided with a first wireless module 21. Wherein, the first wireless module 21 is e.g. but not limited to a Zigbee wireless module which can be used for forming a network group through a household wireless network thereby achieving an objective of controlling a plurality of switches or sockets.

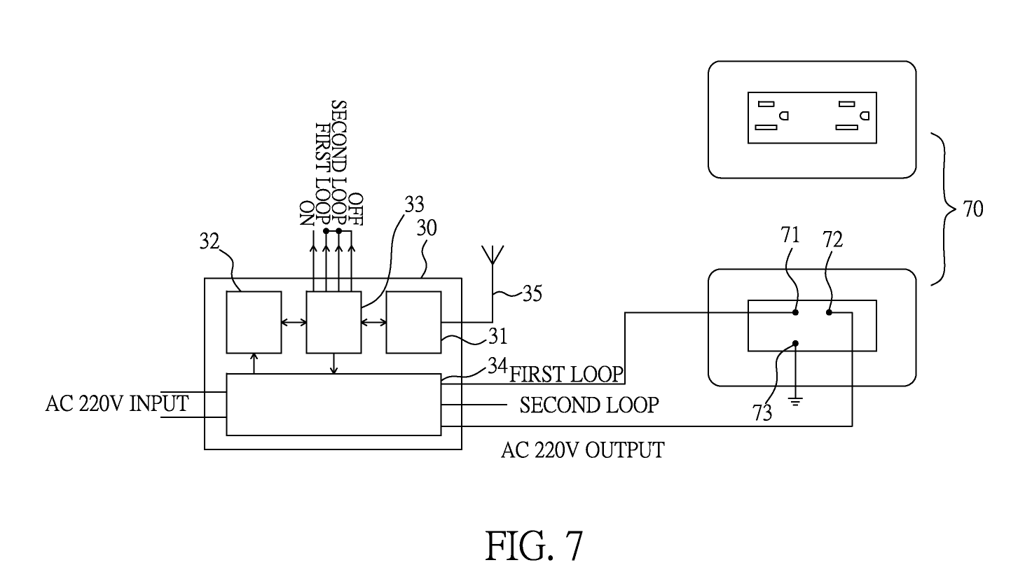

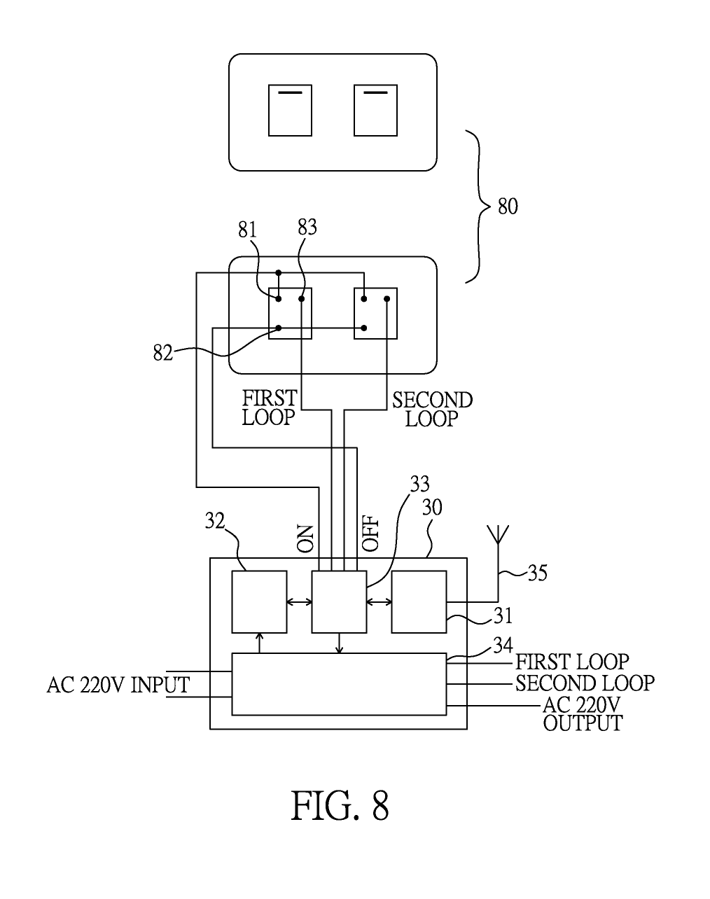

The termination unit 30 is disposed in a patch board (not shown in figures) of a power source and coupled to a switch or a socket (referring to FIG. 7 and FIG. 8), and the switch or the socket is coupled to the above-mentioned computer or the household appliance and the termination unit 30 is provided with a second wireless module 31 for being communicated with the first wireless module 21. Wherein, the second wireless module 31 is e.g. but not limited to a Zigbee wireless module which can be used for forming a network group through a household wireless network thereby achieving the objective of controlling a plurality of switches or sockets.

In addition, the control unit 10 is able to be connected to an internet 50 through a first wireless network device 40, and the switch unit 20 is able to be connected to the internet 50 through a second wireless network device 60 thereby achieving an objective of mutual connection. Wherein, the first wireless network device 40 and the second wireless network device 60 are e.g. but not limited to a household router.

As shown in FIG. 3, the switch unit 20 further includes a network module 22 and a first controller 23. Wherein the network module 22 can be a wired or wireless network module; according to this embodiment, a wired network module is adopted for illustration and shall not be a limitation to the scope of the present invention, and the wired network module is e.g. but not limited to an Ethernet module coupled to the second wireless network device 60. The first controller 23 is e.g. but not limited to a microcontroller , and one end thereof is coupled to the network module 22, and the other end thereof is coupled to the first wireless module 21, and the first controller 23 is provided with a USB port (not shown in figures) for providing a parameter setting function. In addition, the first wireless module 21 is further provided with an antenna 24.

As shown in FIG. 4, the termination unit 30 further includes a power module 32, a second controller 33 and a power switch 34. The power module 32 is used for outputting a 3.3V DC power to the second controller 33. The second controller 33 is e.g. but not limited to a microcontroller, one end thereof is coupled to the power module 32 and the other end thereof is coupled to the second wireless module 31, and the second controller 33 is provided with a USB port (not shown in figures) for providing a parameter setting function. In addition, the second wireless module 31 is further provided with an antenna 35.

When in use, a user can control to turn on or turn off the computer or the household appliance through the application program installed in the control unit 10, for example when a lamp is desired to be turned on, a command is sent by the control unit 10 to the internet 50 through the first wireless network device 40, and the command is sent through the internet 50 to the second wireless network device 60 then sent to the switch unit 20, so the switch unit 20 is able to locate the position where the lamp is installed, then the command is sent to the termination unit 30 corresponding to the lamp; after the termination unit 30 receives the command, the termination unit 30 enables the internal wiring to be conducted for turning on the lamp. What shall be addressed is that the procedure for turning off the lamp or turning on or off other computer or household appliance can be analogized, therefore no further illustration is provided.

Moreover, when the application program of the present invention is served to send the command, the application program can also receive the power consumption information of the computer or the household appliance and allow the information to be shown on the display 11, so the user can use the information for reference or evaluation.

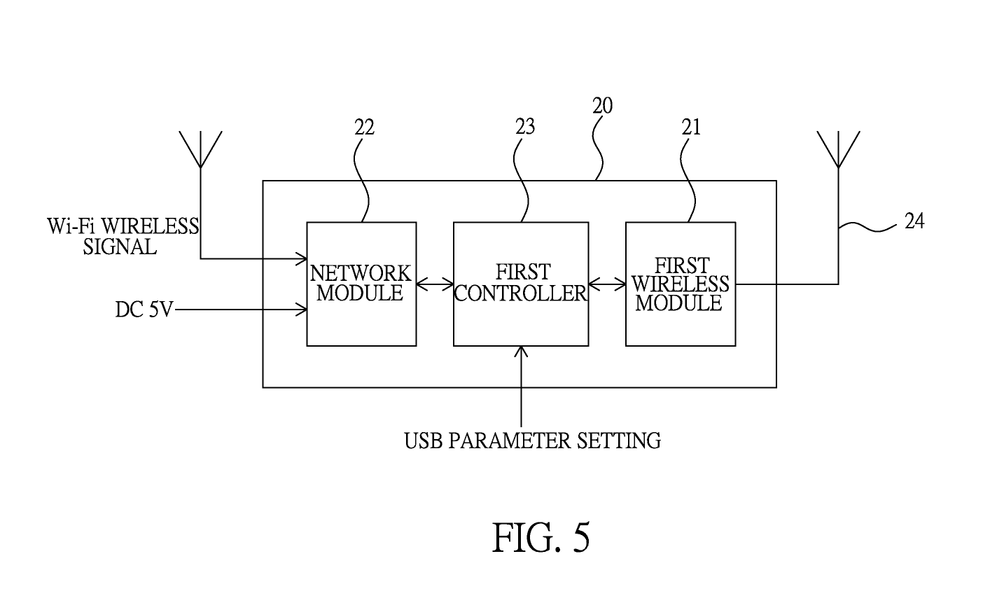

Referring to FIG. 5, which is a block diagram illustrating the switch unit according to another preferred embodiment of the present invention. As shown in FIG. 5, according to another preferred embodiment of the present invention, the network module 22 of the switch unit 20 can also be a wireless network module, e.g. but not limited to a Wi-Fi wireless network module which is connected to the second wireless network module 60 through a Wi-Fi wireless network.

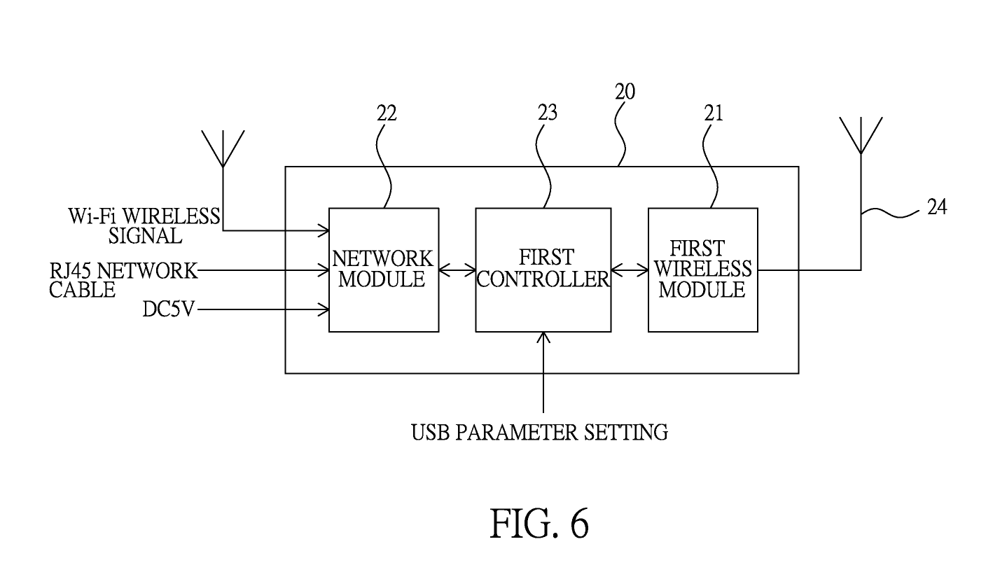

Referring to FIG. 6, which is a block diagram illustrating the switch unit according to one another preferred embodiment of the present invention. As shown in FIG. 6, according to one another embodiment of the present invention, the network module 22 of the switch unit 20 can be provided with both of the wired network and the wireless network functions for being connected to the second wireless network device 60, wherein the wired network is e.g. but not limited to an Ethernet, and the wireless network is e.g. but not limited to a Wi-Fi wireless network module.

Referring to FIG. 7, which is a schematic view illustrating the connection between the termination unit and a socket according to one another preferred embodiment of the present invention. As shown in FIG. 7, according to one another preferred embodiment of the present invention, one end of the power switch 34 of the termination unit 30 is coupled to an AC power source, e.g. but not limited to AC220V, and one end thereof is served to output the AC power source to a socket 70, according to this embodiment, an arrangement of the power switch 34 being able to control two sockets 70 is served for illustration and shall not be a limitation to the scope of the present invention. The output end of the power switch 34 is respectively coupled to a fire terminal 71 and a neutral terminal 72 of the socket 70, and a ground terminal 73 is grounded, so when the second controller 33 receives the command of the control unit 10, the power switch 34 is enabled to actuate or terminate the 220V power source outputted to the socket 70.

Referring to FIG. 8, which is a schematic view illustrating the connection between the termination unit and a switch according to one another preferred embodiment of the present invention. As shown in FIG. 8, according to one another preferred embodiment of the present invention, one end of the second controller 33 of the termination unit 30 is coupled to at least a switch 80, according to this embodiment, an arrangement of the second controller 33 being able to control two switches 80 is served for illustration and shall not be a limitation to the scope of the present invention. An ON signal output end of the second controller 33 is respectively coupled to a first terminal 81 of the switch 80, and an OFF signal output end of the second controller 33 is respectively coupled to a second terminal 82 of the switch 80, and a first control signal and a second control signal of the second controller 33 are respectively coupled to a third terminal 83 of the switch 80; as such, when the second controller 33 receives the command of the control unit 10 for turning on the electronic device controlled by the switch 80 at the left side, the second controller 33 outputs an ON signal to the first terminals 81 of the two switches 80, meanwhile outputs the first control signal to the third terminal 83 of the switch 80 at the left side thereby allowing the switch 80 at the left side to be conducted status for turning on the electronic device controlled by the switch 80 at the left side. As such, the wireless switch for use in internet of things provided by the present invention is novel and more practical in use comparing to prior art.

Based on what has been described above, in the wireless switch for use in internet of things provided by the present invention, at least a termination unit is provided and disposed in the patch board of a power source, so no protrusion is formed on a wall thereby providing a better appearance; an application program is installed in the control unit so the user is allowed to control the wireless switch to be opened or closed through the application program; and the application program is able to display the power consumption status of the electric equipment thereby being provided with an advantage of recoding and managing the power consumption of the relevant product so as to save power. Accordingly, the wireless switch for use in internet of things provided by the present invention is novel and more practical in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims.

Although specific terms are employed herein, they are used in a generic and descriptive sense only and not for purposes of limitation.

What is claimed is:

1. A wireless switch for use in internet of things, comprising:
a control unit, provided with a display installed with an application program;
a switch unit, one end thereof being coupled to said control unit through a wired network or a wireless network, and the other end thereof being provided with a first wireless module; and
a termination unit, disposed in a patch board and coupled to a switch or a socket, said switch or said socket being coupled to a computer or a household appliance, and said termination unit being provided with a second wireless module for being communicated with said first wireless module;
through said application program of said control unit, said switch unit and said termination unit being enabled to control said computer or said household appliance to be turned on or turned off

2. The wireless switch for use in internet of things as claimed in claim 1, wherein said control unit is a hand-held device, said display is a liquid crystal display, and said display is able to show the power consumption information of said computer or said household appliance.

3. The wireless switch for use in internet of things as claimed in claim 1, wherein said switch unit further comprises:
a network module, coupled to said wired network or said wireless network; and
a first controller, one end thereof is coupled to said network module, and the other end thereof is coupled to said first wireless module, and said first controller is provided with a USB port for providing a parameter setting function.

4. The wireless switch for use in internet of things as claimed in claim 3, wherein said network module is an Ethernet module or a Wi-Fi wireless network module, and said first controller is a microcontroller.

5. The wireless switch for use in internet of things as claimed in claim 1, wherein said first wireless module is a Zigbee wireless module and further provided with an antenna.

6. The wireless switch for use in internet of things as claimed in claim 1, wherein said termination unit further comprises:
a power module, used for outputting a 3.3V DC power source;
a second controller, one end thereof is coupled to said power module and the other end thereof is coupled to said second wireless module, and said second controller is provided with a USB port for providing a parameter setting function; and
a power switch, one end thereof is coupled to an AC power source and said second controller and the other end thereof is coupled to said socket, and said power switch is controlled by said second controller for actuating or terminating said AC power outputted to said socket.

7. The wireless switch for use in internet of things as claimed in claim 6, wherein said second controller is a microcontroller.

8. The wireless switch for use in internet of things as claimed in claim 1, wherein said second wireless module is a Zigbee wireless module and further provided with an antenna.

9. The wireless switch for use in internet of things as claimed in claim 1, wherein said control unit is able to be connected to an internet through a first wireless network device, and said switch unit is able to be connected to said internet through a second wireless network device thereby achieving an objective of mutual connection.

10. The wireless switch for use in internet of things as claimed in claim 9, wherein said first wireless network device and said second wireless network device are a router.
